(19) United States
(12) Patent Application Publication
(10) Pub. No.: US 2014/0192837 A1
(43) Pub. Date: Jul. 10, 2014

(54) SYSTEM AND METHOD FOR GENERATING A COMBINED MODEL FOR ISOTHERMAL AND ANISOTHERMAL FATIGUE LIFE

(71) Applicant: Björn Buchholz, Mülheim an der Ruhr (DE)

(72) Inventor: Björn Buchholz, Mülheim an der Ruhr (DE)

(73) Assignee: SIEMENS AKTIENGESELLSCHAFT, München (DE)

(21) Appl. No.: 14/239,854

(22) PCT Filed: Dec. 5, 2011
(86) PCT No.: PCT/EP2011/071712

§ 371 Date: Feb. 20, 2014

(30) Foreign Application Priority Data
Aug. 25, 2011 (EP) 11006943.2

(51) Int. Cl. G01N 3/32

(52) U.S. Cl. CPC G01N 3/32
USPC 374/47

(57) ABSTRACT

To generate a combined model for isothermal and anisothermal fatigue life of a material, multiple strain-controlled fatigue tests are performed on the material. For each test, test data is generated that includes a normalized load and a number of cycles to occurrence of crack initiation in the material under a normalized load which is a function of multiple instantaneous load levels determined at different points in time during the test. Each individual instantaneous load level is determined by normalizing a measured stress at an instant with a value of a temperature dependent property of the material corresponding to a temperature of the test at that instant. The test data from the plurality of strain-controlled tests are processed to generate a combined lifetime model defining a response of the number of cycles to occurrence of crack initiation to the normalized load.

The present invention relates to determination of fatigue characteristics for a material subject to cyclic loading. In particular, the present invention relates to generating a combined model for isothermal and anisothermal fatigue life for a material subject to cyclic mechanical as well as thermal loading.

In a plurality of applications in technical systems, parts or components can be subject to cyclic loading, of mechanical as well as thermal mature, which alternate or vary over time. In such cases individual parts can, for example, be subject to direct mechanical stresses through the occurrence of compressive or tensile forces. A time-varying thermal loading of this type arises on the other hand, for example, for the parts or components in a turbine system, especially in a gas turbine, when the gas turbine is started up or shut down. Extreme cyclic loading, both mechanical and thermal, results in material fatigue, which, in many cases limits the life of the component.

Normally, a large number of material tests are needed in order to assess the lifetime behavior of a material. A typically used test type involves the investigation of the material behavior under fatigue condition in the low cycle fatigue (LCF) region. In these tests, the mechanical strain range, the ratio of the minimum to maximum mechanical strain (R-ratio) and the temperature are specified as test parameters. In general, these tests are typically done at isothermal temperatures and with varying mechanical strain ranges with the goal to calibrate the Coffin-Manson-Basquin model (CMB) according (eq. 1) for the description of the lifetime behavior.

$$\frac{Δ {ɛ}_{me .}}{2} = \frac{{σ}_{{f}^{′}}}{E} {( 2 N )}^{b} + {{ɛ}_{{f}^{′}} ( 2 N )}^{c} \qquad ( eq . 1 )$$

In eq. 1, Δεₘₑis the mechanical strain range, E is the elastic modulus, while σ_{f}, ε_{f}, b and c are parameters which have to be calibrated according the test results of the isothermal fatigue tests.

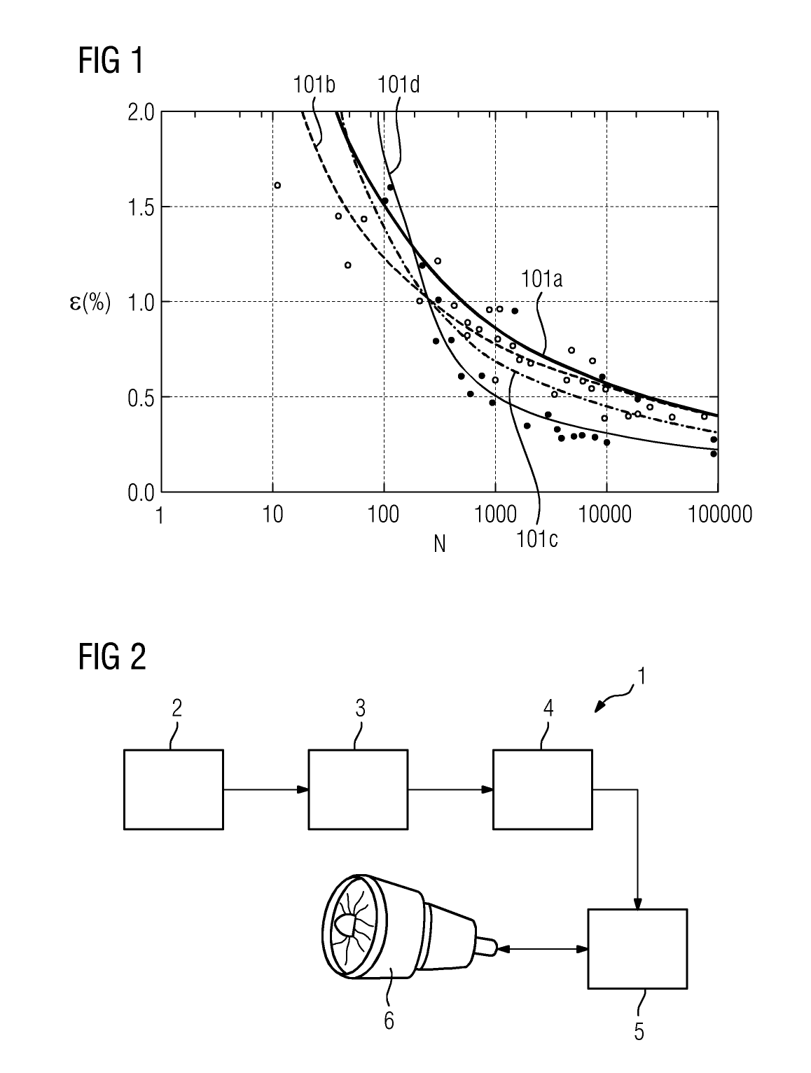

The parameters of the above-described CMB model depend on the test temperature, such that for every temperature, these parameters change. As a result, for every temperature, a different curve results. An exemplary trend for this model and the test data are shown in FIG. 1, wherein the vertical and the horizontal axes respectively represent the strain range ε and the number of cycles to crack imitation N. The curves 101a, 101b, 101c and 101d respectively correspond to LCF tests at 20° C., 750° C., 850° C. and 950° C.

Moreover, in addition to mechanical loading, components of gas turbines are stressed by thermal cyclic loadings due to start and shut down of the turbine engine. The isothermal LCF tests as noted above can not cover the thermal cyclic loadings as they do not cover the temperature dependent interactions.

To approach real engine conditions, thermo-mechanical fatigue (TMF) tests are normally done to include the temperature dependent properties in a better way. TMF tests require the definition of several additional test parameters, for example, the maximum temperature Tₘₐₓ, the minimum temperature Tₘᵢₙ, and phase shift Φ between mechanical and temperature loading (Φ=0 . . . 360°). The results are typically assessed using damage parameters. However, damage parameters vary with the choice of Tmax, Tmin and phase Φ. Thus, for each set of test parameters, a different set of damage parameters need to be determined.

A first example of such damage parameters is discussed in the document: SMITH, K. N.; WATSON, P.; TOPPER, T. H.: A Stress-Strain Function for the Fatigue of Metals. In: Journal of Materials 5 (1970), S. 767-778.

A second example of such damage parameters is discussed in the document: OSTERGREN, W. J.: A Damage Function and Associated Failure Equations for Predicting Hold Time and Frequency Effects in Elevated Temperature, Low Cycle Fatigue. In: Journal of Testing and Evaluation (JTE) Volume 4, Issue 5 (1976).

The requirement for a TMF model is that the isothermal conditions are a special case within the TMF model. The number of cycles to failure, i.e., crack initiation, within the TMF lifing model depends on the temperature range between the minimum and maximum temperatures. If this temperature range is zero, isothermal conditions exist and the LCF model must be ideally the outcome.

However, currently, TMF and LCF test data cannot be described using a single model. This is because the parameters describing the existing models do not combine TMF and LCF conditions in a sufficient way. As a result, a different set of parameters need to be determined for each temperature to be investigated by LCF tests, and for each temperature range to be investigated by TMF tests.

The object of the present invention is to provide a single model which describes both isothermal LCF test data and anisothermal TMF test data.

The above object is achieved by the features of the independent claims. Further advantages are realized by the features of the dependent claims.

Embodiments of the present invention make it possible to describe LCF test data for different test temperatures as well as TMF test data for different test temperature ranges using a single lifing model (i.e. a combined lifetime model) for a given material. The underlying idea of the present invention is to calibrate the lifetime model of a material by performing a plurality of strain-controlled tests on the material, wherein for each test, a normalized load level is determined as a function of a plurality of instantaneous load levels. An instantaneous load level, in turn, is determined by normalizing a measured instantaneous stress with a temperature dependent property of the material whose value corresponds to the instantaneous temperature of the test, i.e., the value of the temperature dependent property of the material at the instantaneous temperature. Also, in each test, the number of cycles to fatigue failure, i.e., crack initiation in the material, is measured. Test data is generated for each test which comprises the normalized load and the number of cycles to fatigue failure. The test data is then processed and a combined lifetime model is generated for the material of the component. The combined lifetime model defines a response of the number of cycles to failure to the normalized load.

Advantageously, the combined lifetime model thus obtained can be used to describe test data for both isothermal LCF tests as well as anisothermal TMF tests. As a further advantage, a significantly lesser number of tests are required to calibrate the model.

In one embodiment, at least one of the tests is an isothermal LCF test, wherein the plurality of instantaneous load levels comprises a first load level and a second load level. In this case, the first load level is determined by normalizing a maximum measured instantaneous stress on the material in the test with a value of the temperature dependent property of the material corresponding to the temperature of the test. The second load level is determined by normalizing a minimum measured instantaneous stress on the material in the test with the value of the temperature dependent property of the material corresponding to the temperature of the test.

In a further embodiment, all of the tests are isothermal LCF tests, each test being carried out at a different temperature. Advantageously, a combined isothermal-anisothermal lifing model can be generated by performing only LCF tests that are significantly less complex to evaluate than TMF tests.

In an alternate embodiment, at least one of the tests is an anisothermal TMF test. Herein, the plurality of instantaneous load levels comprises a first load level and a second load level. In this case, the first load level is determined by normalizing a measured instantaneous stress at a maximum temperature of the test with a value of the temperature dependent property of the material corresponding to said maximum temperature. The second load level is determined by normalizing a measured instantaneous stress at a minimum temperature of the test with a value of the temperature dependent property of the material corresponding to said minimum temperature.

In one embodiment, the temperature dependent property is an ultimate tensile strength of the material. In a further embodiment to this, the normalized load for each strain-controlled test is determined on the basis of a relationship defined by

$$P = a {\vert \frac{σ ( {T}_{min} )}{UTS ( {T}_{min} )} \vert}^{b} + c {\vert \frac{σ ( {T}_{max} )}{UTS ( {T}_{max} )} \vert}^{d} ,$$

wherein

P denotes the normalized load,

Tₘₐₓ and Tₘᵢₙ respectively denote the maximum and the minimum temperature of the test,

UTS(Tₘₐₓ) and UTS(Tₘᵢₙ) respectively denote the ultimate tensile stress of the material at the maximum and at the minimum temperature,

σ(Tₘₐₓ) and σ(Tₘᵢₙ) respectively denote the measured stress on the material at the maximum and at the minimum temperature of the test, and

a, b, c and d are weighing parameters greater than zero.

In one embodiment, the combined lifetime model is generated using a sigmoid model defined by

$$P = \frac{A}{1 + {( \frac{N}{B} )}^{C}} + D ,$$

wherein

P denotes the normalized load,

N denotes the number of cycles to crack initiation, and

A, B, C D are model parameters.

In one embodiment, the test data of the plurality of tests is fed to a modeling device, wherein the processing of the test data to generate the combined lifetime model is performed by the modeling device.

In another aspect, a method for estimating a fatigue life of a component is provided. In this case, instantaneous operational temperatures and corresponding instantaneous operational stresses on the component are determined for multiple operational instants. Further, a normalized operational load on the component is determined. The normalized operational load is determined as a function of a plurality of instantaneous load levels that are determined for different operational instants. Each instantaneous load level is determined by normalizing an instantaneous stress, as determined for a given operational instant, with a temperature dependent property of the material, whose value corresponds to an instantaneous temperature determined for said operational instant. The normalized operational load as determined above is then fed as an input to a fatigue life estimating device, for determining an estimated number of cycles to crack initiation in the component on the basis of the combined lifetime model of the material of the component that is generated as described above.

In one embodiment, the component is a component of a gas turbine, and wherein the instantaneous operational temperatures and the corresponding instantaneous operational stresses are determined by a computerized simulation of an operation of the gas turbine.

According to another aspect, a method for operating a component subject to cyclic loading is provided. The method involves scheduling a downtime or maintenance interval of the component taking into account an estimated fatigue life of said component, the estimated fatigue life being determined by a method as described above.

According to yet another aspect, a system is provided for generating a combined model for isothermal and anisothermal fatigue life of a material subject to cyclic loading. The system includes a testing unit for performing a plurality of strain-controlled fatigue tests on the material, and for generating test data as described above. The system further includes a modeling device for processing the test data generated from the plurality of strain-controlled tests to generate a combined lifetime model defining a response of the number of cycles to crack initiation to the normalized load.

Aspects of the present invention are further described hereinafter with reference to illustrated embodiments shown in the accompanying drawings, in which:

FIG. 1 illustrates the use of a Coffin-Manson-Basquin model to describe LCF test data,

FIG. 2 depicts an exemplary system for managing operation of a component subject to cyclic stress based on fatigue life estimation,

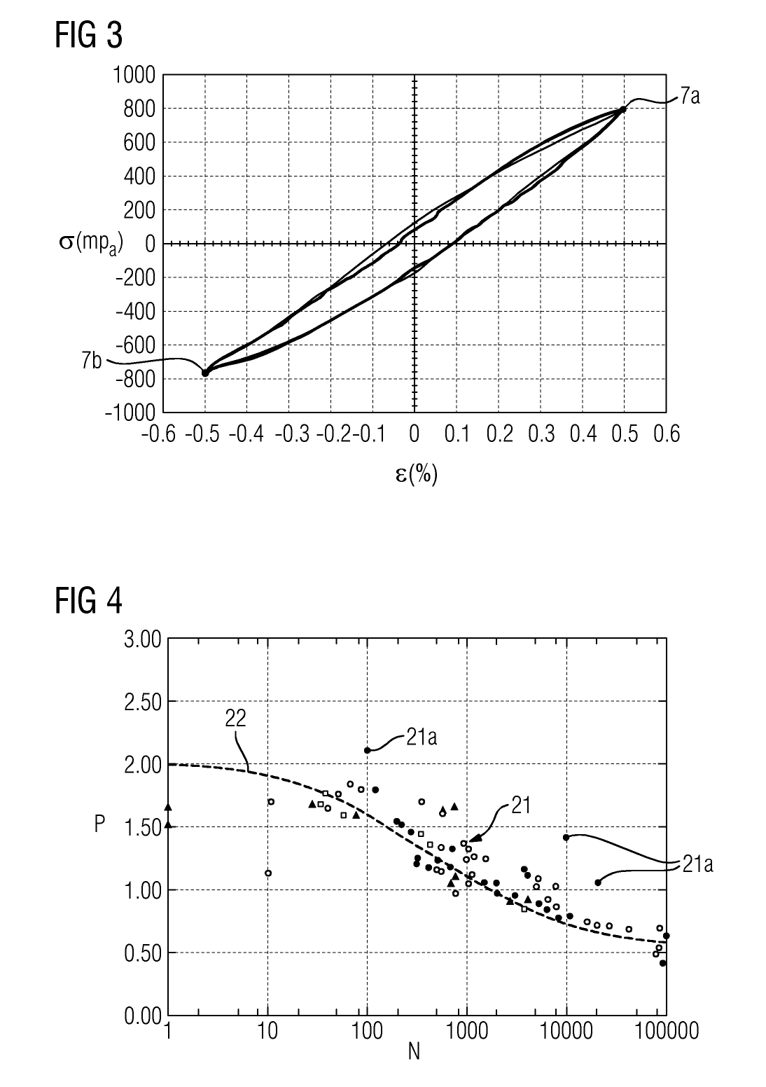

FIG. 3 is an exemplary representation of maximum and minimum stresses in an out-of-phase TMF test,

FIG. 4 illustrates a combined lifetime model in accordance with an embodiment of the present invention,

FIG. 5 illustrates a scheme for mathematically describing a combined lifetime model using a sigmoid function according to one embodiment of the present invention, and

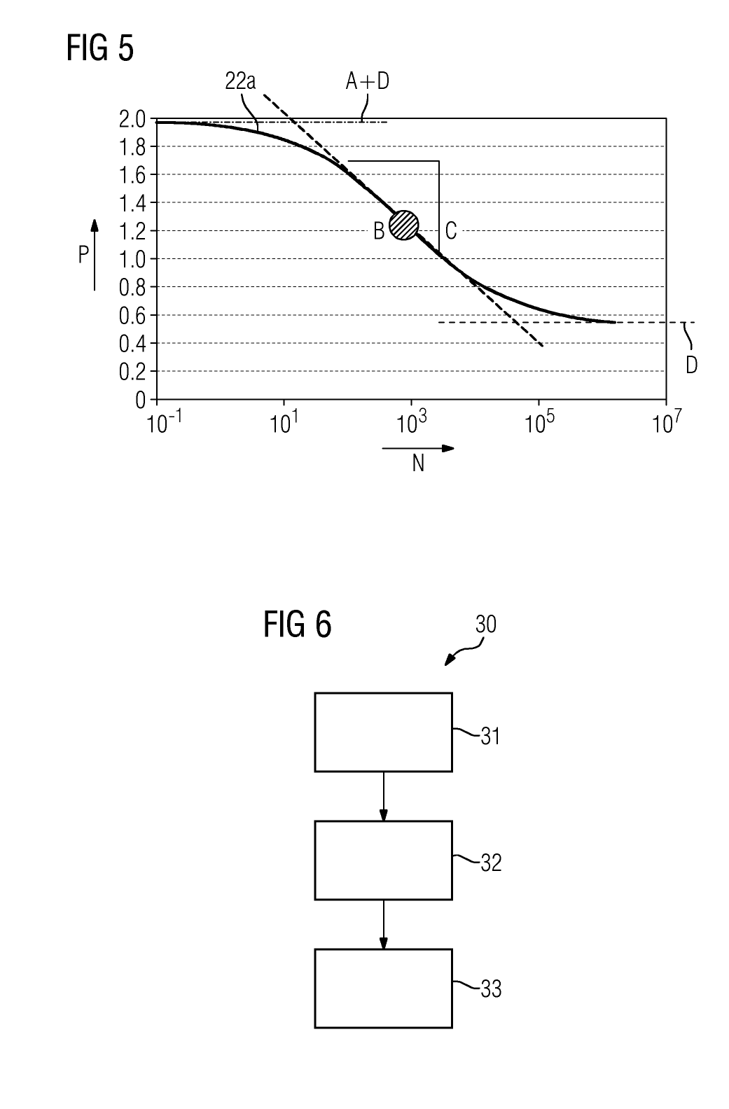

FIG. 6 is a flowchart illustrating an exemplary method for fatigue life estimation using the combined lifetime model of the present invention.

Referring to FIG. 2 is illustrated an exemplary system 1 for operating a component 6 based on fatigue life estimation of the component 6 in accordance with an embodiment of the present invention. In the illustrated embodiment, the component 6 is a gas turbine component that would normally be subject to cyclic loading, both mechanical and thermal, during actual operation. However, the embodiments of the present invention may be applied for any component undergoing cyclic loading, including mechanical and/or thermal loading.

An important aspect of the fatigue process is plastic deformation. Fatigue cracks usually nucleate from plastic straining in localized regions. Therefore cyclic strain-controlled tests have been found to better characterize fatigue behavior of the component than cyclic stress-controlled tests. To that end, the illustrated system 1 broadly includes a testing unit 2 for performing strain-controlled tests on the material of the component 6, a modeling device 3 for processing the test data generated at the testing unit 2 for generating a combined lifetime model of the material, a fatigue life estimating device 4 for determining a fatigue life of the component 6 under operating conditions based on the generated combined lifetime model, and a control unit 5 for controlling downtime or maintenance interval of the component 6 taking into account the estimated fatigue life of the component 6.

The testing unit 2 is used for performing a plurality of strain-controlled tests on the material of the component 6, i.e., on material specimen representative of the component 6. The testing unit 2 may comprise, for example, a servo-controlled closed loop testing machine, a portion (length) of component 6 or the representative specimen having a uniform gage section is subject to axial straining. An extensometer may be attached to the uniform gage length to control and measure the strain over the gauge section. Each strain-controlled test involves applying a completely reversible cyclical mechanical strain having a specified range and R-ratio to the material/specimen and measuring the number of cycles to crack initiation (i.e., fatigue failure) in the material. To that end, a measurement device may be provided in the testing unit 2 for measuring the number of cycles to fatigue failure of the material.

The strain-controlled tests may include, for example, a plurality of LCF tests, each performed isothermally at a specified temperature, in addition to a specified mechanical strain range, and a specified R-ratio. Alternately or additionally, the plurality of strain-controlled tests may include one or more anisothermal TMF tests, each TMF test having further additional test parameters, such as a specified temperature range and a specified phase between thermal and mechanical loading. Typically, in-phase and out-of phase tests are performed for each specified temperature range.

For each strain-controlled test, test data is generated that comprises a normalized load determined for that test, and the number of cycles to crack initiation in the material corresponding to the normalized load. The normalized load is determined as a function of multiple instantaneous load levels determined at different points in time during the test. Each individual instantaneous load level is determined by normalizing a measured stress at an instant with a value of a temperature dependent property of the material corresponding to a temperature of the test at that instant.

TMF tests are generally carried out anisothermally, wherein a reversible cyclic thermal and mechanical loading are provided, i.e., the instantaneous temperatures and stresses vary cyclically in time. In one embodiment, the normalized load for a TMF test is determined as a function of a first and second instantaneous load level on the material, which occur respectively at a maximum temperature and at a minimum temperature of test. FIG. 3 shows an example of the stress (σ)-strain (ε) response of a TMF test with the temperature range 100° C. to 750° C. out-of-phase mechanical and thermal loading, i.e., 180° phase shift in time between mechanical and thermal loading. In FIG. 3, the mechanical strain range is 1.0%. The maximum and minimum stresses are marked as 7a and 7b. In the present example, these stresses occur respectively at the maximum and minimum temperature of the TMF test.

In this example, the instantaneous stress occurring at the maximum temperature and the instantaneous stress occurring at the minimum temperature are each normalized with a temperature dependent material property at the respective temperatures, to respectively define the first load level and the second load level.

In a preferred embodiment, the temperature dependent material property is the ultimate stress (UTS). In such a case the normalized load P for each test may be determined by a summation of the load levels at the maximum and minimum temperatures as per eq. 2 below:

$$P = a {\vert \frac{σ ( {T}_{min} )}{UTS ( {T}_{min} )} \vert}^{b} + c {\vert \frac{σ ( {T}_{max} )}{UTS ( {T}_{max} )} \vert}^{d} \qquad ( eq . 2 )$$

where:

P denotes the normalized load,

Tₘₐₓ and Tₘᵢₙ respectively denote the maximum and the minimum temperature of the test,

UTS(Tₘₐₓ) and UTS(Tₘᵢₙ) respectively denote the ultimate tensile stress of the material at the maximum and at the minimum temperature,

σ(Tₘₐₓ) and σ(Tₘᵢₙ) respectively denote the measured stress on the material at the maximum and at the minimum temperature of the test, and

a, b, c and d are weighing parameters greater than zero.

The values of UTS(Tₘₐₓ) and UTS(Tₘᵢₙ) may be predetermined, for example, from a standard database of material properties of the material of the component. The summation as described in eq. 2 is a weighted summation that depends directly on the values of a, b, c and d.

In an alternate embodiment, instead of the ultimate tensile strength, the yield strength of the material may be used as the temperature dependent material property for determining the normalized load levels.

Although, in the embodiment illustrated above, an out-of-phase TMF test was considered, the normalized load is defined in the same way or an in-phase TMF test.

As seen above, the assessment of the TMF stress response is separated for the minimum and the maximum temperature of each TMF test. Subsequently the individual, temperature dependent damages are summed, to obtain the normalized load for the TMF test.

In case of LCF tests, each test is performed isothermally. Herein again, the plurality of instantaneous load levels includes a first load level and a second load level, the normalized load being a function of said first and second load levels. In this case, the first load level is determined by normalizing a maximum measured instantaneous stress on the material in the test with a value of a temperature dependent property of the material corresponding to the temperature of test. The second load level is determined by normalizing a minimum measured instantaneous stress on the material in the test with the value of a temperature dependent property of the material corresponding to the temperature during the test. Again, the ultimate tensile strength of the material is preferably chosen as the temperature dependent property for determining the normalized load levels.

Generalizing, the normalized load for each test, whether LCF or TMF, is determined as a function of (for example, a weighted summation of) instantaneous values of o/UTS, where o is the instantaneous stress and UTS is the value of the ultimate tensile strength of the material corresponding to the instantaneous temperature of the test.

As shown below, it is possible and sufficient to include test data from only a few LCF tests, without conducting any TMF tests, to calibrate the combined lifetime model.

Referring back to FIG. 2, the test data of each test, comprising the normalized load and number of cycles to crack initiation, is fed to the modeling device 3. The modeling device 3 processes the test data to generate a lifing model, referred to as combined lifetime model, for the material. The combined lifetime model defines a response of the number of cycles to crack initiation to the normalized load, for the given material.

An exemplary combined lifetime model 22 as generated by using the proposed technique is illustrated in FIG. 4. Herein, the curve 22 represents a combined LCF-TMF lifing model defining a variation of number of cycles N with normalized load P, the normalized load P being defined as described above. For validation, the model was applied to test data 21 from a plurality of LCF (isothermal) and TMF (anisothermal) test results 21. Both types of tests were performed with varying parameters and the testing covered a large range of values for the investigated parameters. The test results 21 includes test results from LCF tests for 20° C., 750° C., 850° C. and 950° C., and test results for TMF tests 100-750° C., 100-850° C. and 100-950° C. for both in-phase and out-of-phase thermal and mechanical loading. As shown in FIG. 4, the test results 21 were found to conform closely to the combined lifetime model 22. The only outliers 21a correspond to LCF test results at 20° C., which may be disregarded because the deformation mechanism differs between the high temperature LCF/TMF tests and the LCF tests at 20° C.

In one embodiment, the lifing response (P versus N) is mathematically described using a sigmoid model according to eq.3.

$$P = \frac{A}{1 + {( \frac{N}{B} )}^{C}} + D \qquad ( eq . 3 )$$

The model parameters A, B, C and D are derivable, for example as shown in FIG. 5. Advantageously, the parameters A and D may be predetermined values, such that the tests are performed only for the purpose of determining the parameter B and C. This results in a significant reduction in the number of tests to be performed to calibrate the model.

Referring to FIG. 5, the values of B and C correspond to the coordinates at the point of inflexion of the sigmoid curve 22a. Also, from eq. 3 is clear that the curve 22a is asymptotical with the N-axis at P=A+D and P=D. That is, the maximum and minimum possible values of P are A+D and D respectively.

The parameters A and D may have predefined values derived from material properties of the component. Alternately, the parameter D may be predetermined, for example, from one or more high cycle fatigue tests on the material. The parameter A may be predetermined, for example, from one or more tensile tests on the material. The parameters B and C are then determined by performing a set of LCF and/or TMF tests as described above. Thus, it is possible to calibrate the entire model using test data from a very small number of LCF tests, to determine only the parameters B and C.

Referring back to FIG. 2, the combined isothermal and anisothermal lifetime model of the material generated by the modeling device 3 is used to determine an estimated fatigue life of the component when in operation. This is implemented by the fatigue life estimating device 4. FIG. 6 is an exemplary flowchart illustrating a method 30 of fatigue life estimation in accordance with one embodiment of the invention. At block 31, instantaneous operational temperatures and the corresponding instantaneous stresses are determined for a plurality of operational instants, each operational instant corresponding to an actual operating state/condition of the gas turbine engine. These may be determined, for example, by performing a computerized simulation of an operating state of the gas turbine. To that end, the fatigue estimating device may comprise means for implementing a computer simulation of the gas turbine engine. At block 32, a normalized operational load is determined. The normalized operational load is determined as a function a plurality of instantaneous operational load levels. Each individual instantaneous load level is determined by normalizing an instantaneous operational stress on the component at a respective operational instant (for example, determined by simulation) with a temperature dependent material property of the component. The value of the temperature dependent material property corresponds to an instantaneous temperature at the respective operational instant (for example, determined by simulation).

In the illustrated example, block 32 involves determining σ(T)/UTS(T) at different instants, where T denotes instantaneous temperature.

In the present example, for determining the normalized operational load under anisothermal operational conditions, a relationship similar to eq. 2 would be utilized, wherein P in this case would stand for normalized operational load, Tₘₐₓ and Tₘᵢₙ would respectively denote the maximum and the minimum temperature determined by simulation of the gas turbine operation, and σ(Tₘₐₓ) and σ(Tₘᵢₙ) respectively would denote the stresses determined by simulation at the maximum and at the minimum temperature.

Finally, at block 33, using the normalized operational load as determined above as input, an estimated number of cycles to fatigue failure or crack initiation is determined on the basis of the combined lifetime model of the material that is generated as described above. The combined lifetime model is essentially a response of number of cycles to crack initiation N to normalized load P. Thus for any value of the determined normalized operational load P, the model outputs the corresponding value of N.

The above described embodiment provides estimation of anisothermal fatigue life of a component operable under both thermal and mechanical cyclic loading. However, the same lifetime model can also be used to estimate an isothermal fatigue life of the component.

Referring back to FIG. 2, the output of the fatigue life estimating device 4 may comprise, for example, a prescribed number of cycles of operation for different levels of operational cyclic loading, both thermal and mechanical. Based on the output of this output, the operation of the component 6 may be controlled by the control unit 5. In particular, the control unit 5 may be comprise prognosis means for scheduling and implementing appropriate downtimes or maintenance intervals for the component 6 taking into account the estimated life-span and operating stress on the component 6.

Aspects of the present invention, in particular the modeling device 3, the fatigue life estimation device 4 and the control unit 5, are embodied in one or more computer systems comprising hardware and software suitable to carrying out the method as described above.

While this invention has been described in detail with reference to certain preferred embodiments, it should be appreciated that the present invention is not limited to those precise embodiments. Rather, in view of the present disclosure which describes the current best mode for practicing the invention, many modifications and variations would present themselves, to those of skill in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

1. A method for generating a combined model for isothermal and anisothermal fatigue life of a material subject to cyclic loading, the method comprising:
performing a plurality of strain-controlled fatigue tests on the material;
generating test data for performance of each strain-controlled test by:
determining a normalized load on the material, wherein the normalized load is a function of a plurality of instantaneous load levels determined at different points in time during the test, wherein each instantaneous load level is determined by normalizing a measured instantaneous stress at a respective point in time with a temperature dependent property of the material wherein the temperature dependent property has a value which corresponds to an instantaneous temperature of the test at the respective point in time;
measuring a number of cycles to occurrence of crack initiation in the material corresponding to the normalized load;
wherein the test data comprises the determined normalized load and the measured number of cycles to occurrence of crack initiation; and
processing the test data generated from the plurality of strain-controlled tests to generate a combined lifetime model for the material defining a response of the number of cycles to occurrence of crack initiation to the normalized load.

2. The method according to claim 1, wherein at least one of the tests is an isothermal LCF test, and wherein:
the plurality of instantaneous load levels comprises a first load level and a second load level;
determining the first load level by normalizing a maximum measured instantaneous stress on the material with a value of the temperature dependent property of the material corresponding to the temperature of the test; and
determining the second load level by normalizing a minimum measured instantaneous stress on the material in the test with the value of the temperature dependent property of the material corresponding to the temperature of the test.

3. The method according to claim 2, wherein all of the tests are isothermal LCF tests, and each of the tests is carried out at a respective different temperature.

4. The method according to claim 1, wherein at least one of the tests is an anisothermal TMF test, and wherein:
the plurality of instantaneous load levels comprises a first load level and a second load level;
determining the first load level by normalizing a measured instantaneous stress at a maximum temperature of the test with a value of the temperature dependent property of the material corresponding to the maximum temperature; and
determining the second load level by normalizing a measured instantaneous stress at a minimum temperature of the test with a value of the temperature dependent property of the material corresponding to the minimum temperature.

5. The method according to claim 1, wherein the temperature dependent property is an ultimate tensile strength of the material.

6. The method according to claim 4, wherein the temperature dependent property is an ultimate tensile strength of the material and wherein the normalized load for each strain-controlled test is determined on the basis of a relationship defined by
P=α|σ(Tₘᵢₙ)/UTS(Tₘᵢₙ)|^{b}+c|σ(Tₘₐₓ)UTS(Tₘₐₓ)|^{d},|

wherein
P denotes the normalized load,
Tₘₐₓ and Tₘᵢₙ respectively denote the maximum and the minimum temperature of the test,
UTS(Tmₐx) and UTS(Tₘ±ₙ) respectively denote the ultimate tensile stress of the material at the maximum and at the minimum temperature,
o(Tₘₐₓ) and σ(Tₘ±ₙ) respectively denote the measured stress on the material at the maximum and at the minimum temperature of the test, and
aᵣ bᵣ c and d are weighing parameters greater than zero.

7. The method according to claim 1, further generating a combined lifetime model using a sigmoid model defined by
$$P = \frac{A}{1 + ( \frac{N}{B} )} + D ,$$
wherein
P denotes the normalized load,
N denotes the number of cycles to occurrence of crack initiation, and
A, B, Cᵣ D are model parameters.

8. The method according to claim 1, further comprising feeding the test data of the plurality of strain-controlled tests to a modeling device, and performing the processing of the test data to generate the combined lifetime model by the modeling device.

9. A method for estimating fatigue life of a component operable under cyclic loading, comprising:
determining instantaneous operational temperatures and corresponding instantaneous operational stresses on the component for a plurality of operational instants;
determining a normalized operational load on the component, as a function of a plurality of instantaneous operational load levels determined for different operational instants, wherein each instantaneous operational load level is determined by normalizing an instantaneous operational stress on the component, as determined for a respective operational instant, with a temperature dependent material property of the component wherein the temperature dependent material property has a value which corresponds to an instantaneous temperature as determined for the respective operational instant; and
providing the determined normalized operational load to a fatigue life estimation device, for determining an estimated number of cycles to occurrence of crack initiation in the component on the basis of a combined lifetime model corresponding to the material of the component, and generating the combined lifetime model by the method according to claim 1.

10. The method according to claim 9, wherein the component is a component of a gas turbine, and wherein the instantaneous operational temperatures and the corresponding instantaneous operational stresses are determined by a computerized simulation of an operation of the gas turbine.

11. A method for operating a component under cyclic loading, comprising:
scheduling a downtime or maintenance interval of the component taking into account an estimated fatigue life of the component, and determining the estimated fatigue life by a method according to claim 9.

12. A system for generating a combined model for isothermal and anisothermal fatigue life of a material subject to cyclic loading, the system comprising:
a testing unit configured and operable for performing a plurality of strain-controlled fatigue tests on the material, the testing unit comprising:
a load determining device for determining a normalized load on the material for each test, wherein the normalized load is a function of a plurality of instantaneous load levels determined at different points in time during the test, and wherein each instantaneous load level is determined by normalizing a measured instantaneous stress at a respective point in time with a temperature dependent property of the material wherein the temperature dependent material property has a value which corresponds to an instantaneous temperature of the test at the respective point in time;
a measurement device for measuring a number of cycles to occurrence of crack initiation in the material corresponding to the normalized load of each test;
wherein the testing unit is configured to generate test data comprising the determined normalized load and the measured number of cycles to occurrence of crack initiation; and
a modeling device configured and operable for processing the test data generated from the plurality of strain-controlled tests for generating a combined lifetime model defining a response of the number of cycles to occurrence of crack initiation to the normalized load.
